(19) United States
(12) Patent Application Publication
(10) Pub. No.: US 2005/0262487 A1
(43) Pub. Date: Nov. 24, 2005

(54) System, apparatus, and method for identifying authorization requirements in component-based systems

(75) Inventors: Marco Pistoia, Yorktown Heights, NY (US); Lawrence Koved, Pleasantville, NY (US); Paolina Centonze, Yorktown Heights, NY (US)

Correspondence Address: Louis J. Percello;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/842,805

(22) Filed: May 11, 2004

(51) Int. Cl. G06F 9/45

(52) U.S. Cl. 717/143; 717/127

(57) ABSTRACT

Improved detecting the authorization requirements and defining the security policies for an application comprising one or more components is disclosed. A call and resource-access graph is used to model all the possible paths of execution within the application. Then, paths of execution detected during the analysis are combined with the access control information found in the security policy of the application. Finally, for each authorization point in the application, a minimal security policy is reported that the executing principal should be granted in order to pass the authorization successfully.

### FIELD OF THE INVENTION

This invention relates to security requirements for software. More specifically, the invention relates to access rights in composed software and components, particularly used in enterprise applications.

### BACKGROUND OF THE INVENTION

Composed software systems comprise multiple, possibly heterogeneous, and potentially distributed components. As such, they present special security requirements. In particular, security requirements may vary component by component depending on the resources that each component attempts to access. Components are software or data elements that have contractually specified interfaces, conform to a standard model, and can be independently deployed and composed without modifications according to the composition standard. These data elements include, but are not limited to, static files such as HTML, XML, or static image files, as well as multimedia resources such as video and audio files. Some components may be a combination of data and software, such as HTML documents containing JavaScript code. Some components may be the result of composition of other components.

Traditional software systems employ user- or principal-based access control models that protect systems from malicious entities, but do not take into account the location from which the component is coming and the owners or authors of the code. In contrast, the security architecture of some modern software systems does consider the heterogeneous nature of these systems. Component-based systems, such as Java 2, Enterprise Edition (J2EE) and Microsoft .NET, allow system administrators to manage authentication and authorization to access protected resources based on the principal running the code. However, other component-based systems may also perform authentication and authorization based on the origin of the component, which may include the owners or authors of the component.

Another difference between the security of some traditional software systems and that of modern enterprise systems involves authorization granularity. In traditional systems, authorization is coarse, comparatively speaking. System administrators grant either full access to the system resources or no access at all. The authorization models for recent component-based systems have been designed to be fine-grained. This means that system administrators can specify in detail which operations code can and cannot do, based on the component's origin and/or the principal running it. For example, a system administrator can decide that all components coming from a particular network location, digitally signed by certain entities and run or used by specified principals are granted access only to a particular file in the file system. Additionally, it is even possible to specify, for example, that the type of access is limited to read-only access, while authorization for write, delete, and execute access is denied.

As enterprise systems have evolved, the type of resources that are protected has also changed. In traditional systems, authorization was focused on protecting local system resources, such as the file system, operating system, network, etc. Modern component-based systems, such as the Java 2, Enterprise Edition (J2EE) and Microsoft .NET platforms, allow system administrators to protect other resources. For example, it is possible to specify that access to a certain Uniform Resource Locator (URL), Universal Resource Identifier (URI) or a family of URLs and URIs matching a certain pattern is allowed only to a particular principal or class of principals. Similarly, it is possible to specify that certain functions in a particular software component (for example, the method transferMoney( ) on a BankAccount software component) can be invoked only by a particular principal or set of principals.

For example, the J2EE security architecture defines a class of resources that are protected. In J2EE, it is possible to protect specific Web resources, such as URLs as well as Enterprise JavaBeans (EJB) methods. It is possible to specify that a particular EJB method can be accessed only by principals who have been granted a specific security role. A security role is a semantic grouping of access rights assigned to principals of an enterprise system. So, for example, it is possible to specify that method method1( ) in enterprise bean Bean1 can be accessed only by those principals who have been assigned the role of Professor. If user “bob” successfully logs in and attempts to execute, directly or indirectly, method1( ) in the enterprise bean Bean1, the method invocation will succeed only if “bob” has previously been assigned the role of Professor. The Microsoft .NET authorization model is very similar.

Both J2EE and Microsoft .NET promote the concept of declarative security. This means that it is not necessary to embed authentication and authorization code within an application. Rather, the security information is stored with other deployment information in configuration files that are external to the application code. In J2EE, such configuration information is known as deployment descriptors. A system administrator deploying Bean1 must be aware that its method1( ) can only be accessed by principals assigned the role of Professor, and will have to assign that role to users accordingly.

Problems with the Prior Art

Problems arise in complex enterprise applications. Specifically, enterprise bean methods call each other, resulting in long call chains. In the example of FIG. 1, if method1( ) (102) on a Bean1 instance is the first method of one of such chains, and to invoke this method the calling principal must have been assigned the role of Professor, the invocation of method1( ) may fail even if the user “bob” (101) invoking it had been granted the required role of Professor. Specifically, if method1( ) in turn invokes another method (104) in another enterprise bean using Remote Method Invocation (RMI) over the Internet Intra-ORB Protocol (IIOP) (103), the identity of user “bob” is propagated to the second method call (unless the deployment descriptor specifies a different role in the “run-as” policy, which means that the identity of a principal with this new role will be used instead of the “bob” identity). If the second method in the chain can only be invoked by principals with the role of Student, and user “bob” was not assigned such a role, the underlying system will detect that user “bob” was not granted the role of Student. Therefore, this second method invocation will be denied, and the first call—the one to method1( )—will not complete successfully. In these cases, the system administrator needs to discover why the method1( ) method invocation failed.

The following listing shows the J2EE deployment descriptor fragment that protects method1( ) in enterprise bean Bean1 so that only principals who have been granted the role of Professor can invoke method1( ):

```
<method-permission>
  <role-name>Professor</role-name>
  <method>
    <ejb-name>Bean1</ejb-name>
    <method-intf>Remote</method-intf>
    <method-name>method1</method-name>
  </method>
</method-permission>
```

Similarly, the following listing shows the J2EE deployment descriptor fragment that protects method2( ) in enterprise bean Bean2 so that only principals who have been granted the role of Student can invoke method2( ):

```
<method-permission>
    <role-name>Student</role-name>
    <method>
        <ejb-name>Bean2</ejb-name>
        <method-intf>Remote</method-intf>
        <method-name>method2</method-name>
    </method>
</method-permission>
```

In a J2EE environment, if user “bob” has not been additionally granted the role of Student or if the appropriate J2EE “run-as” security policy has not been specified, an error similar to the following will be generated:
Application threw an exception:java.rmi.ServerException:
RemoteException occurred in server thread; nested exception is:
java.rmi.RemoteException: nested exception is:
java.rmi.AccessException: CORBA NO_PERMISSION 9998

The error reported often does not give enough information to understand why the method invocation failed. The system administrator can perform an analysis to determine the reason of the authorization failure. The system administrator can check the deployment descriptor associated with the Bean1 enterprise bean, see that method1( ) can be accessed only by users who have been granted the role of Professor, and verify that user “bob” was granted the role of Professor. Understanding the reason of the failure may require reading the deployment descriptors and source code of all the methods in the enterprise bean method call chain. This is a difficult, tedious, and error-prone task. Additionally the source code is not always available, as it may have been written by different software developers or organizations and composed to create the deployed application.

The situation becomes even more confusing if method1( ) on a Bean1 instance invokes method2( ) on a Bean2 instance locally (without using the RMI-IIOP protocol). In this case, the underlying J2EE system is not required to check the security roles for access to method2( ) and the method invocation will succeed even if “bob” was not granted the role of Student. The difference in behavior between local and remote method invocations makes it even harder for system administrators to figure out the authorization requirements.

Dynamic analysis is limited because it relies on having a complete set of test cases covering all possible paths through the set of components in an application. In the absence of a complete set of test cases, authorization failures may remain undiscovered until the code is deployed in the enterprise, rendering the enterprise code unstable.

Aspects of the Invention

An aspect of this invention is an improved system and method to find authorization requirements and/or policies for enterprise applications.

An aspect of this invention is an improved system and method to find authorization requirements and/or policies for enterprise applications without requiring a comprehensive set of test cases that exercise all execution paths in a set of components that comprise an application.

An aspect of this invention is an improved system and method to assist developers, system administrators, deployers, and others involved in defining and configuring security policies for an application comprised of one or more software components.

An aspect of this invention is an improved system and method that assists in defining security policies that conform to the “Principle of Least Privilege”.

### SUMMARY OF THE INVENTION

The present invention provides a system, method, and apparatus for implementing a new mechanism that assists in detecting the authorization requirements and defining the security policies for an application comprising one or more components. One preferred embodiment of this invention uses a call and resource-access graph to model all the possible paths of execution of the application at runtime. Then, the invention combines the paths of execution detected during the analysis with the access control information found in the security policy of the application. Finally, for each authorization point in the application, the invention reports a minimal security policy that the executing principal should be granted in order to successfully pass the authorization test.

### BRIEF DESCRIPTION OF THE FIGURES

These and other aspects, features, and advantages of the present invention will become apparent upon further consideration of the following detailed description of the invention when read in conjunction with the drawing figures, in which:

FIG. 1 is diagram showing a prior art authorization scenario failing on an enterprise system.

FIG. 2 is a block diagram of one embodiment of the present invention.

FIG. 3 is a flow chart of a static analysis process.

FIG. 4 is a flow chart of a server/user interaction process.

FIG. 5 is diagram showing an authorization scenario on an enterprise system using the static analysis of the present invention.

### DETAILED DESCRIPTION OF THE INVENTION

With embodiments of the present invention, it is possible to analyze an application and detect its authorization requirements statically, which means that it is not necessary to run the application. Since the application is not executed in this analysis phase, malicious application code cannot harm the system on which the application code is analyzed. Additionally, the present invention does not require any test case and relieve system administrators, deployers, developers, and all the others involved in defining the application's security policy from the burden of manually inspecting the application in order to detect the application's authorization requirements.

Rather than relying on dynamic analysis, this invention presents a static analysis technique for automatically computing security authorization requirements in existing enterprise code. While the analysis techniques described in this introduction are in the context of J2EE application code, the basic techniques are applicable to access control analysis issues in non-Java component-based systems, including Microsoft .NET.

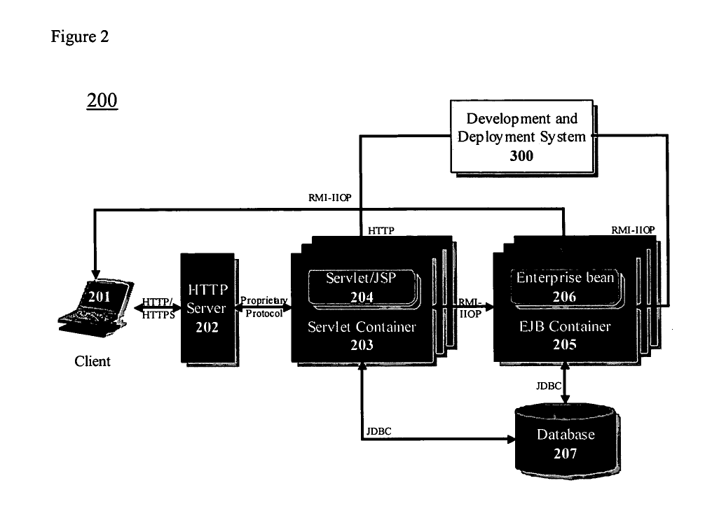

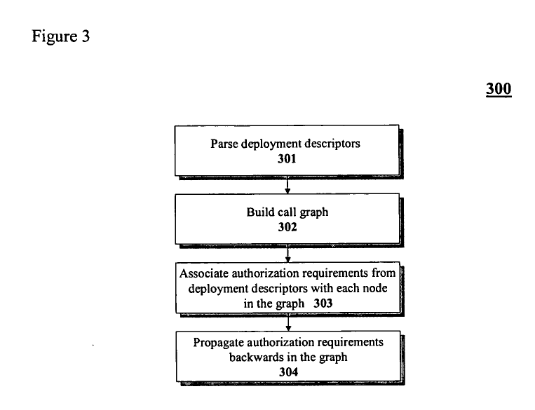

FIG. 2 shows the network environment 200 in which the Developing and Deployment System 300 for process of FIG. 3 is located. In a J2EE enterprise system 200, a client 201 makes a request to a HyperText Transfer Protocol (HTTP) server using the HTTP protocol. To protect the confidentiality of the data transmitted and ensure authentication, the HTTP request can be carried over the Secure Sockets Layer (SSL) protocol. The protocol HTTP over SSL is known as HTTPS. To provide the client with dynamic and personalized contents, the server may invoke one or more Java programs known as servlets. The code of a servlet can be either written in a standalone file or embedded into a HyperText Markup Language (HTML) page. In this latter case, the Java application providing the dynamic content is known as a JavaServer Pages (JSP) application. Servlets and JSP applications 204 run on a platform known as Web container, or servlet container 203.

Frequently, a servlet or JSP application needs to interact with a database or another backend system before being able to provide the client with dynamic content. The J2EE specification recommends embedding the business logic of an enterprise application into Enterprise JavaBeans (EJB) components 206. EJB components are Java programs running on an EJB container 205 and accessible through the RMI-IIOP protocol. EJB components can also be accessed directly from a J2EE client using RMI-IIOP.

The flow chart in FIG. 3 shows the novel static analysis process 300 in detail. This invention presents a static analysis technique for automatically computing security authorization requirements in existing enterprise code. The deployment descriptors of all the application components (such as servlets, JSP applications, and enterprise beans) are parsed (301) using any well known parsing technique. The control flow of the component-based application is analyzed (302) for the purposes of building a call and resource-access graph. This includes the control flow resulting from remote methods invoked over a remote procedure call mechanism, such as RMI-IIOP (103). Security authorization information is associated with each URL/URI and enterprise bean method.

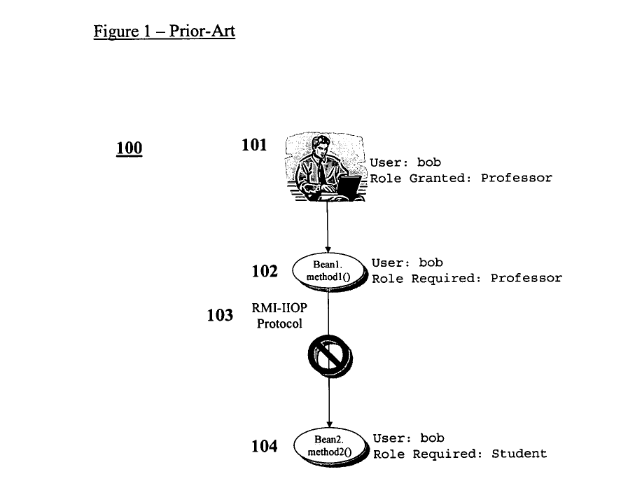

Since each node in the call and resource access graph corresponds to a URL/URI or enterprise bean method invocation, security authorization information is associated with each node in the call and resource-access graph (303) using an association process 303. For example, in the scenario described in FIG. 1, method1( ) in Bean1 (102) would be associated with the security role of Professor, and method2( ) in Bean2 (104) would be associated with the security role of Student. The analysis of the deployment descriptors would then make a note of whether the principal's security credentials are to be propagated from method1( ) to method2( ) or the calling principal's security credentials are to be replaced with the security credentials of another principal having a specified security role, based on a “run-as” policy specified in the deployment descriptor. For example, in the scenario described in FIG. 1, the security credentials of the principal are simply propagated without any substitution. The analysis (304) would detect that both the security roles of Professor and Student are necessary to successfully invoke method1( ), not just the security role of Professor as a superficial analysis of the deployment descriptor would reveal. See below for a more detailed description of the propagation process (304).

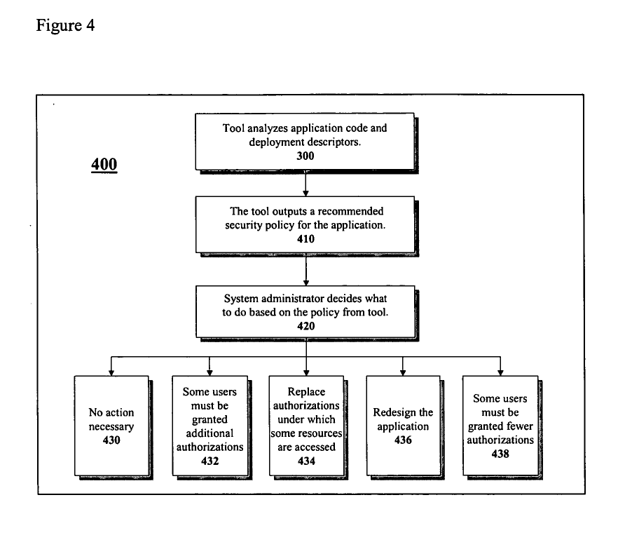

At this point, the server/user interaction process of FIG. 4 shows that the system or security administrator 400 has several options:

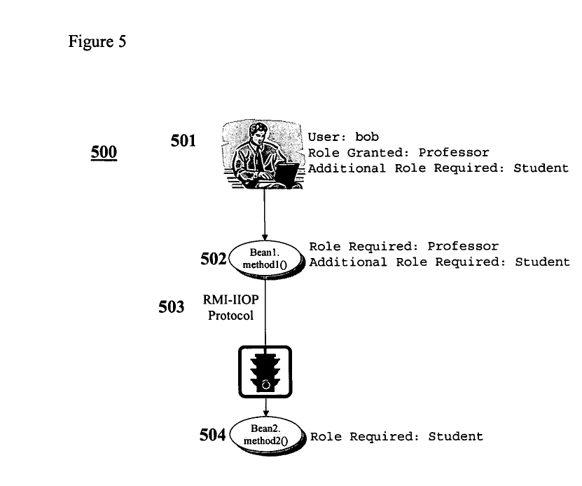

1. Choose to assign the security role of Student to the principal invoking method1( ) (432). In a more general case, this means that some users must be granted additional authorizations (432). This is the scenario depicted in FIG. 5.

2. Replace the principal's security credentials at the point of invoking method2( ) with the security credentials of a principal who has already been granted the role of Student (434). In a more general case, this means replacing the authorizations under which some resources are accessed (434).

3. Redesign the application or take other actions if 1. and 2. violate the intended security design objectives or policy (436).

In some cases, the analysis may reveal that some users were granted too many roles, a situation that violates the “Principle of Least Privilege”. In such cases, the recommended action is to grant those users only the roles that are strictly necessary to run the application. Therefore, those users will have to be granted fewer roles (438).

In other cases, the analysis may confirm that the security policy was well defined, and that all the users were granted exactly those roles strictly necessary to run the application. In such cases, the system administrator will not have to take any action (430), and will be reassured that the security policy is neither too restrictive (which would make the application unstable) nor too permissive (which would make the application unsecure).

Specifically, FIG. 4 shows how the present invention can be used by the system administrator or deployer of an enterprise application to improve the reliability of the application without compromising the security of the application and without violating the “Principle of Least Privilege”.

This invention enhances the security and stability of enterprise applications. This invention considers all the possible execution paths within the application. This implies that if there is an execution path for which a particular security role is required, that execution path is discovered during the analysis, and the system administrator can choose whether to grant the necessary security role. No runtime path will be excluded by the static analysis. This improves code stability and eliminates the potential authorization failures that would be generated at runtime. In most cases, alternative solutions, such as manually examining the code or performing dynamic analysis of the code, do not ensure that all the possible invocation paths have been examined, especially when the code being analyzed is large and complex, and the invocation paths depend on inputs from the user.

Additionally, assuming a sufficiently precise control flow analysis of the software components, this invention assists in enforcing the security rule known as the “Principle of Least Privilege” by correctly identifying the minimal set of security roles that need to be assigned to the principals attempting access to the applications. The present invention extends to the J2EE environment the invention of access rights analysis for J2SE applications, described in U.S. patent application entitled AUTOMATED PROGRAM RESOURCE IDENTIFICATION AND ASSOCIATION to Koved et al. filed on May 11, 2001, Ser. No. 09/854,031, which is herein incorporated by reference in its entirety.

The present invention provides a method and apparatus for determining which security roles a principal must be assigned to access components or collections of components in an enterprise application. An enterprise application, including some or all of its components, is analyzed by performing static analysis on the components and configuration information. This may include analyzing components that could be accessed locally or remotely. Typically, the result of the static analysis is a call and resource-access graph. Each node in the call and resource-access graph represents a method or resource; if nodes A and B in the call and resource-access graph are connected by an edge, that means that accessing the method or resource represented by A leads to accessing the method or resource represented by B. From the application security policy and/or the components, the security roles associated with each component and resource are identified from existing configuration information. Those are the security authorizations or roles that must be granted to a principal accessing the resources. Note that configuration information can be deployment descriptors, security policies, XML files, application settings, a configuration database, or any other stored information that is used by the application during the execution of the application.

It is possible to use context sensitivity to reduce the conservativeness of the analysis and potentially minimize the number of authorizations that would be identified to be required by the principal invoking a component (such as a URL/URI or EJB method).

One preferred propagation process (304) used to achieve the purpose of the present invention involves using fixed-point iteration. All the nodes of the call and resource-access graph are put into a work queue. (In a preferred embodiment only the nodes on which authorization test are performed are put into the work queue.) Each node in a call and resource-access graph has a set of security roles associated with it. Initially, each set either is empty or contains the security roles necessary to access the resource as specified in the deployment descriptor associated with the resource represented by the node. A resource is a element of a component that can be accessed and used as part of an application. Examples of resources include methods or procedures on software, URL/URI, text, images, XML, and files. Using fixed-point iteration, the nodes are extracted from the work queue one by one. For each node n, the set of its predecessors is identified. Each predecessorp of n is examined. If the edge fromp to n represents a remote method invocation and if the deployment descriptors did not specify in a “run-as” policy that the security credentials of the principal invoking n should be replaced with the security credentials of another principal whose security role is in n's set, then the set of security roles currently associated with n is unioned with the set of roles currently associated with p, and the set of security roles resulting from this set union operation is associated with p. If the set of security roles associated with node p has changed because of this operation, then p itself is put into the work queue, ifp is not already there. This process is guaranteed to terminate because the universe of all the roles associated with an enterprise application is finite. Furthermore, this process terminates only after having mapped each node with the set of security roles required to access that node's resource.

FIG. 5 shows the situation (an authorization scenario) in which
n is a remote invocation of method2( ) on a Bean2 instance (504),
p is an invocation of method 1 on a Bean1 instance (502),
the set N of security roles initially associated with n contains only the security role of Student, and
the set of security roles initially associated with p contains the role of Professor.

Using the security role propagation algorithm just described, the system administrator is able to detect that the original security failure was due to user “bob”'s lacking the role of Student when invoking method1( ). With this invention it is possible to determine the required security roles without having to run the application.

In conclusion, the algorithm presented by this invention identifies the security roles needed to execute a component-based application. This information can be used to improve the security, usability, and reliability of those enterprise applications without violating the “Principle of Least Privilege”.

1. A system for determining authorization requirements on component based computer systems, the system comprising:
one or more inputs for receiving one or more configuration informations associated with each respective component, the components each having one or more resources;
a parser that parses all of one or more authorization requirements from the configuration informations to create a preliminary set of authorization requirements associated with each of the resources of each of the components; and
a propagation process that propagates the configuration informations through a call and resource-access graph so that each of one or more parent nodes in the call and resource-access graph is associated with a set of authorization requirements that include all of the authorization requirements of each of the child nodes of the parent node, the propagation continuing until there are no more changes of authorization requirements in any of the nodes of the call and resource-access graph.

2. A system for determining authorization requirements on component based computer systems, the system comprising:
one or more inputs for receiving one or more components and configuration information, the configuration information associating each of the components with one or more runtime characteristics of the component, and the components each having one or more resources;
a parser that parses all of one or more authorization requirements from the configuration information to create a preliminary set of authorization requirements associated with each of the resources of each of the components;
a call and resource-access graph builder that builds a directed call and resource-access graph that defines a calling structure of each of the resources in each of the components;
an association process that associates the preliminary set of authorization requirements with each of the respective resources on the call and resource-access graph; and
a propagation process that propagates the authorization requirements through the call and resource-access graph so that each of one or more of the parent nodes in the call and resource-access graph is associated with a set of authorization requirements that include all of the authorization requirements of each of the child nodes of the parent node, the propagation continuing until there are no more changes of authorization requirements in any of the nodes of the call and resource-access graph.

3. A system for determining authorization requirements on component based computer systems, the system comprising:
one or more inputs for receiving one or more components, the components each having one or more resources;
a call and resource-access graph builder that builds a directed call and resource-access graph that defines a calling structure of each of the resources in each of the components;
an association process that associates a preliminary set of authorization requirements with each of the respective resources on the call and resource-access graph; and
a propagation process that propagates the authorization requirements through the call and resource-access graph so that each of the parent nodes of the call and resource-access graph is associated with a set of authorization requirements that include all of the authorization requirements of each of the child nodes of the parent node, the propagation continuing until there are no more changes of authorization requirements in any of the nodes of the call and resource-access graph.

4. A system, as in claim 1, where the propagation process is a fixed-point iteration process.

5. A system, as in claim 1, where each of the resources is given the authorization requirements in the final new set of authorization requirements in the node of the call and resource-access graph associated with the respective resource.

6. A system, as in claim 1, where a system administrator does not give one or more of the resources the respective final new set of authorization requirements and the component is re-designed to prevent a security fault.

7. A system, as in claim 1, where the resources include any one or more of the following:
a method, a URL, a URI, text, image, XML, multimedia content, and a file.

8. A system, as in claim 2, where the propagation process is a fixed-point iteration process.

9. A system, as in claim 2, where each of the resources is given the authorization requirements in the final new set of authorization requirements in the node of the call and resource-access graph associated with the respective resource.

10. A system, as in claim 2, where a system administrator does not give one or more of the resources the respective final new set of authorization requirements and the component is re-designed to prevent a security fault.

11. A system, as in claim 2, where the resource includes any one or more of the following:
a method, a URL, a URI, text, image, XML, multimedia content, and a file.

12. A system, as in claim 3, where the propagation process is a fixed-point iteration process.

13. A system, as in claim 3, where each of the resources is given the authorization requirements in the final new set of authorization requirements in the node of the call and resource-access graph associated with the respective resource.

14. A system, as in claim 3, where a system administrator does not give one or more of the resources the respective final new set of authorization requirements and the component is re-designed to prevent a security fault.

15. A system, as in claim 3, where the resource includes any one or more of the following:
a method, a URL, a URI, text, image, XML, multimedia content, and a file.

16. A computer system for providing authorization requirements for software resources, the system comprising:
one or more inputs for receiving one or more components and configuration information, the configuration information associating each of the components with one or more runtime characteristics of the component, and the components each having one or more resources; and
one or more outputs that provide a mapping of one or more authorization requirements.

17. A system, as in claim 16, where the mapping maps one or more of the resources to one or more of the authorization requirements that are needed to access the resource.

18. A system, as in claim 16, where the mapping maps one or more of the components to one or more of the authorization requirements that are needed to access the component.

19. A system, as in claim 16, where the mapping includes one or more of the following: a list, a file change, a file, a graphical user interface, a deployment descriptor, and a multimedia file.

20. A system, as in claim 16, that further provides an indication of one or more unnecessary authorization requirements.

21. A system, as in claim 20, where an administrator removes one or more of the unnecessary authorization requirements.

22. A system, as in claim 16, that further provides an indication of one or more additionally needed authorization requirements.

23. A system, as in claim 22, where an administrator adds one or more of the additionally needed authorization requirements.

24. A system, as in claim 16, where an administrator redesigns one or more components based on the indication about authorization requirements.

25. A system, as in claim 16, where an administrator redesigns one or more resource authorization requirements based on the indication about authorization requirements.

26. A system, as in claim 16, where an administrator redesigns one or more configuration informations based on the indication about authorization requirements.

27. A system, as in claim 16, where the configuration information is one or more of the following: a deployment descriptor, a security policy, an XML file, an application settings, and a configuration database.

28. A method for providing authorization requirements for software resources, the system comprising:
receiving one or more components and one or more configuration informations, the configuration informations associating each of the components with one or more runtime characteristics of the component, and the components each having one or more resources; and
mapping of one or more authorization requirements into one or more requirement sets.

29. A method, as in claim 28, where the requirements sets are mapped to one or more of the resources.

30. A method, as in claim 28, where the requirement sets are mapped to one or more of the components.

31. A system for determining authorization requirements of component based computer systems, the system comprising:
receiving one or more components and one or more configuration informations, the configuration informations associating each of the components with one or more runtime characteristics of the component, and the components each having one or more resources;
parsing all of one or more authorization requirements from the configuration informations to create a preliminary set of authorization requirements associated with each of the resources of each of the components;
building a directed call and resource-access graph that defines a calling structure of each of the resources in each of the components;
associating the preliminary set of authorization requirements with each of the respective resources on the call and resource-access graph; and
propagating the authorization requirements through the call and resource-access graph so that each of one or more parent nodes of the call and resource-access graph is associated with a set of authorization requirements that include all of the authorization requirements of each of the child nodes of the parent node, the propagation continuing until there are no more changes of authorization requirements in any of the nodes of the call and resource-access graph.

32. A system for providing authorization requirements for software resources, the system comprising:
means for receiving one or more components and one or more configuration informations, the configuration informations associating each of the components with one or more runtime characteristics of the component, and the components each having one or more resources; and
means for mapping of one or more authorization requirements into one or more requirement sets.
